(19) United States
(12) Patent Application Publication
(10) Pub. No.: US 2007/0279525 A1
(43) Pub. Date: Dec. 6, 2007

(54) Audience detection for increasing component longevity

(76) Inventors: Kuohua Wu, Corvallis, OR (US); David L. Erickson, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/444,641

(22) Filed: Jun. 1, 2006

(51) Int. Cl. H04N 7/00; H04N 7/18; H04N 5/30; G08B 21/00

(52) U.S. Cl. 348/552; 348/162; 348/156; 340/686.6

(57) ABSTRACT

A system for increasing component longevity in a display device includes: a display device; a sensor for detecting an audience associated with the display device; and a control subsystem connected to the sensor. The control subsystem is configured to deactivate at least one component of the display device when no audience is detected by the sensor. A method of increasing component longevity includes determining the presence or absence of an audience with respect to a display device; and deactivating at least one component of the display device when the audience associated with the display device is not present.

### BACKGROUND

Display devices, including projection systems, are commonly found in homes, offices, and public places. Through a variety of technologies, they display visual information that can be viewed by anyone in the vicinity. Examples of such devices include, but are not limited to, television sets, computer monitors, flat panel displays, front and rear projection televisions and other image projection systems.

However, the displays of these devices are generally activated continuously, whether or not an audience is present to view the displayed media. The portion of time that display devices are activated without an audience is often substantial. Unnecessary activation of display components during this time wastes power and shortens the life of the activated equipment.

For example, lamps essential to many projection systems commonly have a lifetime of 2,000 operating hours or less. Plasma screens, a popular form of a flat-panel display, generally have a lifetime of only 30,000 hours and are also vulnerable to image burn-in if activated for extended periods.

### SUMMARY

A system for increasing component longevity in a display device includes: a display device; a sensor for detecting an audience associated with the display device; and a control subsystem connected to the sensor. The control subsystem is configured to deactivate at least one component of the display device when no audience is detected by the sensor. A method of increasing component longevity includes determining the presence or absence of an audience with respect to a display device; and deactivating at least one component of the display device when the audience associated with the display device is not present.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 is a schematic diagram of an audience detection system, according to one exemplary embodiment.

FIG. 2 is a schematic block diagram of an audience detection system for increased component longevity, according to one exemplary embodiment.

FIG. 3 is a flowchart of a method of increasing component longevity incorporating audience detection, according to one exemplary embodiment.

Throughout the drawings, identical reference numbers designate similar, but not necessarily identical, elements.

### DETAILED DESCRIPTION

The present exemplary methods and systems are adapted to detect an audience of a display device and increase the longevity of display device components. Specifically, a present exemplary method may deactivate at least one display device component when a detection system indicates that a suitable audience is not present. Further details of the present exemplary audience detection systems and methods will be provided below.

As used in the present specification and in the appended claims, the term “audience” is defined to include at least one person who is located so as to be capable of viewing at least some portion of the information or programming displayed by a display device. For purposes of example only, a person might be considered an audience if the person were located within a certain distance from, and range of angles with respect to, the display device so as to effectively view displayed information or programming. The specific conditions indicating the presence of an audience may vary from embodiment to embodiment.

Additionally, as used in the present specification and in the appended claims, the term “visual media” is defined to include text, video, images, web pages, or any other information that may be displayed on a display device for viewing by an audience.

Similarly, as used in the present specification and in the appended claims, the term “subsystem” is defined to include hardware, software, firmware, memory, and/or control logic that assist a system to function, even though the components may not be explicitly referenced. A subsystem may further include means for interfacing with other systems or subsystems, converting or distributing power, processing data, or enabling additional features.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

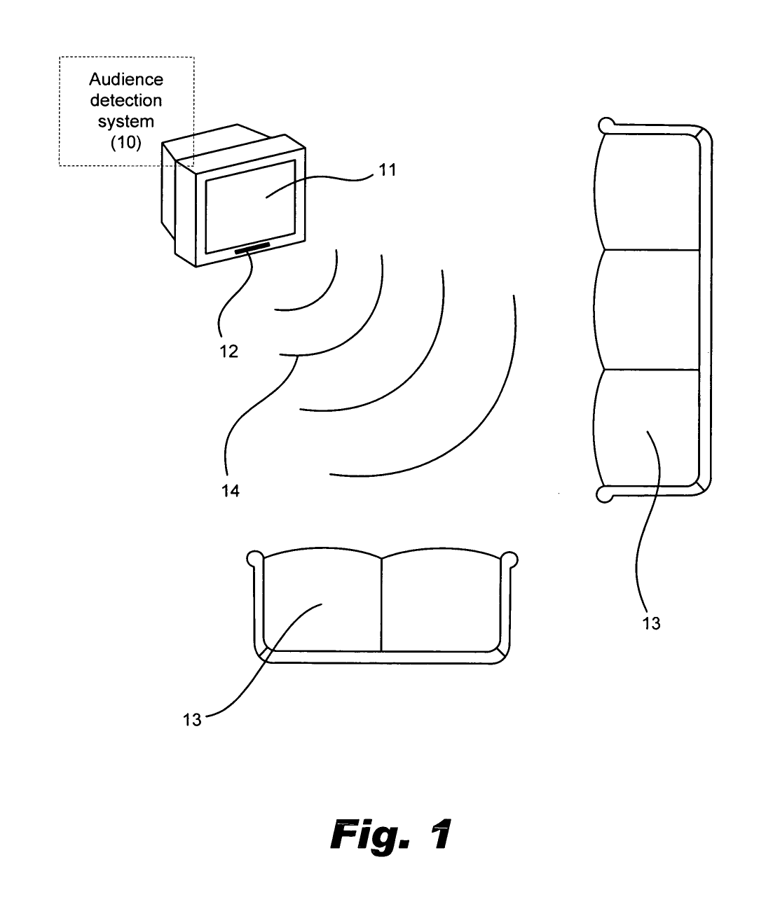

FIG. 1 illustrates a system for detecting an audience and increasing the longevity of a display device or particular display device component, according to one exemplary embodiment.

As shown in FIG. 1, an audience detection system (10) is incorporated into a display device (11). The audience detection system (10) includes at least one sensing mechanism (12) for sensing an indication that an audience is present so as to be able to view information or programming displayed by the display device (11). Various embodiments of the display device (11) may also include power, sound, control, and other subsystems.

The display device (11) may include, but is not limited to, a television, computer monitor, projector, electronic sign, lamp, or any other means of displaying visual media. Specifically, the display device (11) may include, but is in no way limited to, a cathode ray tube (CRT), liquid crystal display (LCD), plasma display, light emitting diode (LED), incandescent lamp, fluorescent lamp, filament lamp, laser, or any other light source, including those containing halogen, mercury, xenon, argon, krypton, or sodium. In addition to a light source and/or display means, the display device may include additional subsystems for processing, reception, and/or transmission of information.

The audience detection system (10) employs at least one sensing mechanism (12) to determine if a suitable audience is present. Although the embodiment depicted in the figure indicates an active sensor which may emit a wave (14), additional embodiments may incorporate passive sensors that do not transmit energy. Sensing mechanism (12) may include, but is not limited to, motion detectors, heat sensors, cameras, and proximity detectors.

When the display device (11) is activated, the vicinity of the display device (11) is monitored using the sensing mechanism (12) to determine the presence or absence of an audience (13). The vicinity of the display device (11) that is monitored may be adjusted based on the particular surroundings and environment of the display device (11) to take in a range of area in which an audience would be expected to reside, if present. This vicinity may be monitored constantly, periodically, in response to a pre-defined condition, or according to the pre-defined settings of at least one user of the system.

In the embodiment of FIG. 1, the absence of an audience is represented by empty couches (13) from which a least one person could potentially view the display device (11). According to the embodiment of FIG. 1, the sensing mechanism (12) would indicate to the audience detection system (10) that no audience is present. Consequently, at least one display device component or subsystem would be deactivated to increase the longevity of the deactivated component or subsystem and thus, potentially, of the display device (11) as a whole. Additionally, the deactivation of at least one component or subsystem will reduce the power consumed by the system.

In one embodiment, the display device (11) is a projector that operates using a xenon lamp. Xenon lamps provide many advantages in projection display systems. However, the typical life of Xenon lamp may be short compared to other competitive light sources such as Ultra-High Performance (UHP) lamps, LEDs, lasers, etc. Consequently, deactivating the xenon lamp of a projection display system when no audience is present extends the life of the xenon lamp and renders the xenon lamp more competitive with other light sources for projection applications.

It is common for an audience to activate a display device, such as a television system, and then leave the vicinity of the display device. The viewer may leave momentarily to complete a some task or errand. Consequently, when the sensing mechanism (12) indicates that an audience is present, the previously deactivated component or subsystem is re-activated and the system resumes normal operation. In other instances, the user of the display device may simply wish to hear the programming or other audio information from the display device without watching the visual display. Consequently, in some embodiments, when no audience is detected, the display device may be programmed, by the manufacturer or the user, to disable only visual display components which audio production components continue to operate for the audience that is not present in the vicinity of the display device so as to watch a visual display but who are nevertheless within earshot.

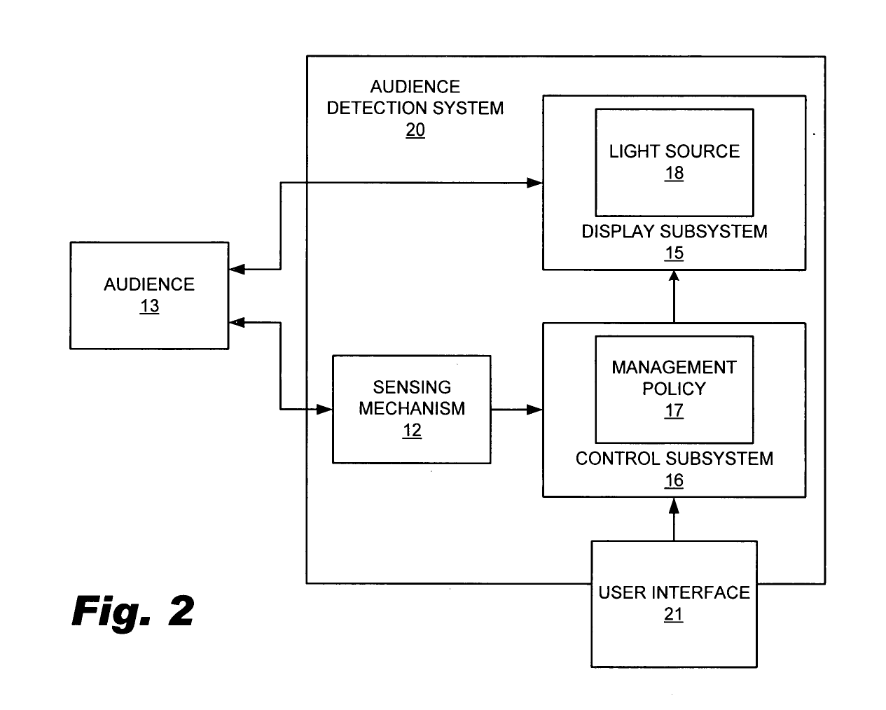

FIG. 2 illustrates the components of system for detecting an audience and increasing the longevity of a display device as a block diagram, according to one exemplary embodiment. In the embodiment of FIG. 2, the display device that is controlled by the audience detection system (20) is considered to be a subsystem (15) of the audience detection system (20).

As illustrated, the audience detection system (20) includes a control subsystem (16), a display subsystem (15), and at least one sensing mechanism (12).

The display subsystem (15) includes all components necessary to display visual media for an audience (13). Specifically, the display subsystem includes at least one light source (18) as explained above.

At least one sensing mechanism (12) may detect, but is in no way limited to detecting, visible light, infrared light, heat, vibrations, sound, ultrasonic waves, motion, and proximity or any other factor indicative of the presence or absence of an audience. Accordingly, the sensing mechanism (12) may include at least one camera, infrared camera, motion detector, proximity detector, light sensor, heat sensor, microphone, laser, radar, or other sensing device. Multiple sensing mechanisms (12) may be used to detect an audience more accurately. As mentioned above, the sensing mechanism (12) may be passive, active, or a combination of the two approaches.

A control subsystem (16) receives and interprets sensor data from at least one sensing mechanism (12). To determine whether sensor data indicates the presence of a suitable audience, the control subsystem (16) applies at least one management policy (17).

Management policies (17) may employ a variety of algorithms to interpret data gathered from sensing mechanism (12). In one embodiment including a proximity sensor, a management policy (17) may only consider a person within a certain radius to be an audience. The management policy (17) may be pre-configured and, in some embodiments, may be configurable, at least in part, by a user of the system. Thus, the system (20) may include a user interface (21) for the control subsystem (16). This user interface (21) may be any device with which a user can edit or control the management policy (17), for example, a keypad, buttons, remote control unit, touchpad, etc. With the user interface (21), the user may be able, for example, to adjust the management policy to control under what circumstances an audience is considered to be present or absent. This may take into account the particular use, surroundings and environment of the system.

Some embodiments may employ a management policy (17) which considers a sleeping person to be an absent audience and accordingly deactivates at least one component of the display subsystem (15), such as light source (18). In such an example, an infrared sensor may indicate that a person is present, a proximity sensor may indicate that the person is within viewing range, but a motion sensor may indicate that no motion has occurred for a certain interval of time indicating that the person is asleep and, therefore, is treated as an absent audience. In some embodiments, the audio system may additionally or alternatively be deactivated if an audience is determined to be unconscious.

Similarly, another management policy (17) may distinguish between the presence of a small animal and a person based on the size and/or location of the features detected.

The control subsystem (16) also sends control signals to the display subsystem (11) to activate at least one component of the display subsystem (11) when an audience (13) is present or deactivate at least one component of the display subsystem (11) when no audience (13) is present. In one embodiment, the control subsystem (16) deactivates a light source (18) when no audience (13) is detected and activates a light source (18) when an audience (13) is detected. Alternatively, the control subsystem (16) may deactivate a component of the display subsystem other than a light source (18) or activate or deactivate multiple components of the system. One embodiment may deactivate a power subsystem to reduce power consumption.

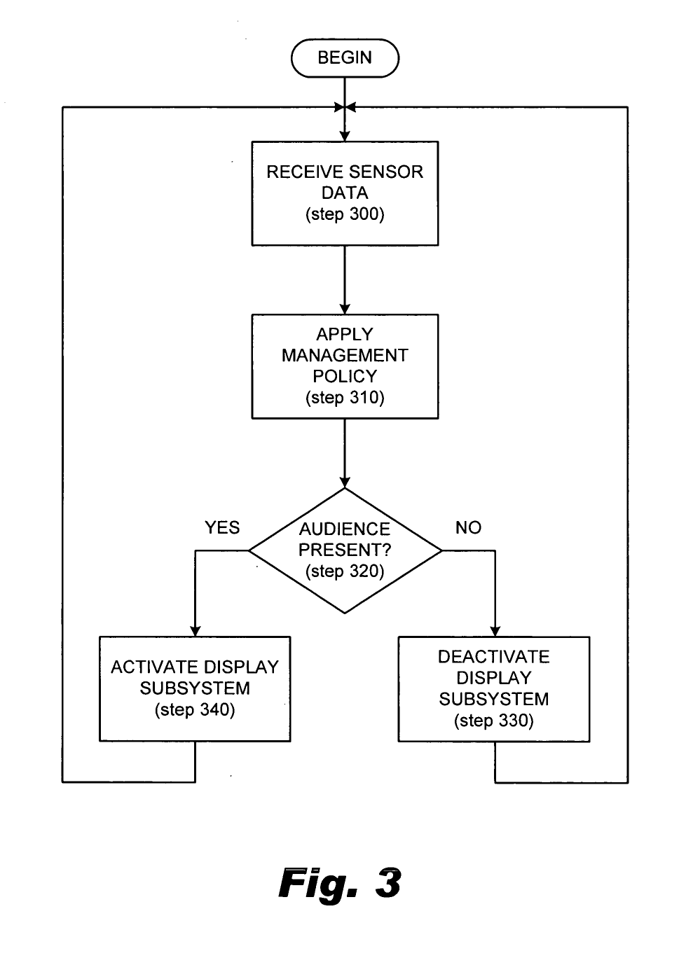

FIG. 3 illustrates a method of detecting an audience and extending the life of a display device or a component of a display device, according to one exemplary embodiment.

Initially, data is received from at least one sensing mechanism (step 300).

Next, at least one policy (17; FIG. 2) for interpreting sensor data is applied to the received data (step 310).

Based on the sensor data received and the results of the one or more policies managing the system, it is determined if a suitable audience is present (step 320). If an audience is present, at least one display subsystem is activated, or remains activated if activated previously (step 340).

If no audience is present, at least one display subsystem is deactivated to extend the life of the system and/or conserve power (step 330).

The method then repeats by receiving additional sensor data (step 300). Sensor input may be monitored continuously, periodically, or according to one or more conditions or events detected by the system.

The preceding description has been presented only to illustrate and describe embodiments of the invention. It is not intended to be exhaustive or to limit the invention to any precise form disclosed. Many modifications and variations are possible in light of the above teaching.

What is claimed is:

1. A system for increasing component longevity, comprising:
a display device;
a sensor for detecting an audience associated with said display device; and
a control subsystem connected to said sensor, wherein said control subsystem is configured to deactivate at least one component of said display device when no audience is detected by said sensor.

2. The system of claim 1, wherein said control system is configured to activate said at least one component when an audience is present.

3. The system of claim 1, wherein said at least one component comprises a light source.

4. The system of claim 3, wherein said light source comprises at least one of a xenon lamp, Light Emitting Diode or laser.

5. The system of claim 1, wherein said at least one component comprises a power subsystem for providing power to said display device.

6. The system of claim 1, wherein said sensor comprises a motion sensor.

7. The system of claim 1, wherein said sensor comprises a camera.

8. The system of claim 1, wherein said sensor comprises a proximity sensor.

9. The system of claim 1, wherein said sensor comprises a heat sensor.

10. The system of claim 1, further comprising a management policy of said control subsystem.

11. The system of claim 10, further comprising a user interface of said control subsystem for adjusting said management policy.

12. The system of claim 1, wherein said sensor is configured to detect an unconscious audience, said control subsystem being configured to deactivate said at least one component of said display device when said unconscious audience is detected.

13. A method of increasing component longevity, comprising:
determining the presence or absence of an audience with respect to a display device; and
deactivating at least one component of said display device when said audience associated with said display device is not present.

14. The method of claim 13, further comprising reactivating said display device component when said audience is present.

15. The method of claim 13, wherein said determining the presence or absence of an audience comprises receiving sensor data and applying a policy for interpreting said sensor data.

16. The method of claim 15, further comprising receiving user input through a user interface of said display device to make changes to said policy.

17. The method of claim 13, wherein said display device component comprises a light source.

18. The method of claim 17, wherein said light source comprises at least one of a xenon lamp, Light Emitting Diode or laser.

19. The method of claim 13, wherein determining the presence or absence of an audience further comprises determining whether said audience is unconscious and deactivating said at least one display device component when said audience is unconscious.

20. A system for increasing component longevity, comprising:
a display device;
means for detecting an audience associated with said display device; and
means for to deactivating at least one component of said display device when no audience is detected by said means for detecting.
